(19) United States
(12) Patent Application Publication
(10) Pub. No.: US 2026/0279848 A1
(43) Pub. Date: Sep. 17, 2026

(54) FUEL CELL

(71) Applicant: HONDA MOTOR CO., LTD., Tokyo (JP)

(72) Inventors: Tomoki HORI, Wako-shi (JP); Naoki INOUE, Wako-shi (JP); Yu YAMAGUCHI, Wako-shi (JP); Yutaka EBATO, Wako-shi (JP); Tadashi NISHIYAMA, Wako-shi (JP)

(21) Appl. No.: 19/550,584

(22) Filed: Feb. 26, 2026

(30) Foreign Application Priority Data
Mar. 12, 2025 (JP) 2025-039796

(51) Int. Cl. H01M 8/0271; H01M 8/0202; H01M 8/0247

(52) U.S. Cl. CPC H01M 8/0271; H01M 8/0247; H01M 8/0269

(57) ABSTRACT

A fuel cell includes an end unit located adjacent to a cell stack. The end unit includes: a current collecting plate that is made of a conductive plate and has a current collector being a tongue; an insulating tray with a plate shape that includes a receiving recess that receives the current collector; an end plate that is made of conductive plate; and an end-side sealing that seals a gap between the receiving recess and the current collector. The current collecting plate, the insulating tray, and the end plate are stacked together in this order, starting from the cell stack.

### CROSS-REFERENCE TO RELATED APPLICATIONS

The present application claims the priority under 35 U.S.C. §119 of Japanese Patent Application No. 2025-039796, filed on Mar. 12, 2025, the contents of which are hereby incorporated by reference in its entirety.

### BACKGROUND OF THE DISCLOSURE

### 1. Field of the Disclosure

The present disclosure relates to a fuel cell that includes a plurality of cell stacks stacked in a thickness direction.

### 2. Description of the Related Art

Some embodiments of a fuel cell include a membrane electrode assembly interposed between a pair of separators as a cell stack that is stacked to form a stacked body. The stacked body has both ends each provided with an end unit having a terminal plate from which power required as a fuel cell is outputted. Such a fuel cell includes a sealing member between the end plate and the terminal plate, which together constitute the end unit, with the sealing member compressed and held in place. The end plate or the terminal plate is provided with an indicator to confirm a relative position of the end plate and the terminal plate. Such a configuration allows for confirmation of any deformation or displacement of the separators caused by the sealing member under a compression reaction force .

### SUMMARY OF THE DISCLOSURE

However, a configuration proposed in Japanese Patent Application Publication No. 2006-040586 includes a terminal plate that is deformed by a compression reaction force from a sealing member, possibly producing a gap in a current collector. This may cause condensed water to enter the gap due to temperature changes.

The present disclosure has been made in view of the above issues and aims to provide a fuel cell that prevents condensed water from entering and reduces instability of power generation, thereby improving energy efficiency.

To achieve the above object, a fuel cell of the present disclosure includes an end unit located adjacent to a cell stack. The end unit includes: a current collecting plate that is made of a conductive plate and has a current collector being a tongue; an insulating tray that is made of an insulating plate and includes a receiving recess that receives the current collector; an end plate that is made of conductive plate; and an end-side sealing that seals a gap between the receiving recess and the current collector. The current collecting plate, the insulating tray, and the end plate are stacked together in this order, starting from the cell stack.

The fuel cell of the present disclosure prevents condensed water from entering and reduces instability of power generation, thereby improving energy efficiency.

### BRIEF DESCRIPTION OF DRAWINGS

FIG. 1 is a plan view showing an end unit included in a fuel cell of a first embodiment;

FIG. 2 is an enlarged view of a region A of FIG. 1;

FIG. 3 is an exploded perspective view of parts shown in FIG. 2;

FIG. 4 is a cross-sectional view taken along a line B-B of FIG. 2;

FIG. 5 is a cross-sectional view taken along a line C-C of FIG. 2;

FIG. 6 is a cross-sectional view taken along a line D-D of FIG. 2;

FIG. 7 is an exploded perspective view of parts of a second embodiment, corresponding to FIG. 2;

FIG. 8 is a cross-sectional view taken along a line corresponding to the line B-B of FIG. 2;

FIG. 9 is a cross-sectional view taken along a line corresponding to the line C-C of FIG. 2;

FIG. 10 is a cross-sectional view taken along a line corresponding to the line D-D of FIG. 2;

FIG. 11 is an exploded perspective view of parts of a third embodiment, corresponding to FIG. 2;

FIG. 12 is a cross-sectional view taken along a line corresponding to the line B-B of FIG. 2;

FIG. 13 is a cross-sectional view taken along a line corresponding to the line C-C of FIG. 2;

FIG. 14 is a cross-sectional view taken along a line corresponding to the line D-D of FIG. 2;

FIG. 15 is an exploded perspective view of parts of a fourth embodiment, corresponding to FIG. 2;

FIG. 16 is a cross-sectional view taken along a line corresponding to the line B-B of FIG. 2;

FIG. 17 is a cross-sectional view taken along a line corresponding to the line C-C of FIG. 2; and

FIG. 18 is a cross-sectional view taken along a line corresponding to the line D-D of FIG. 2;

### EMBODIMENTS OF THE DISCLOSURE

### First Embodiment

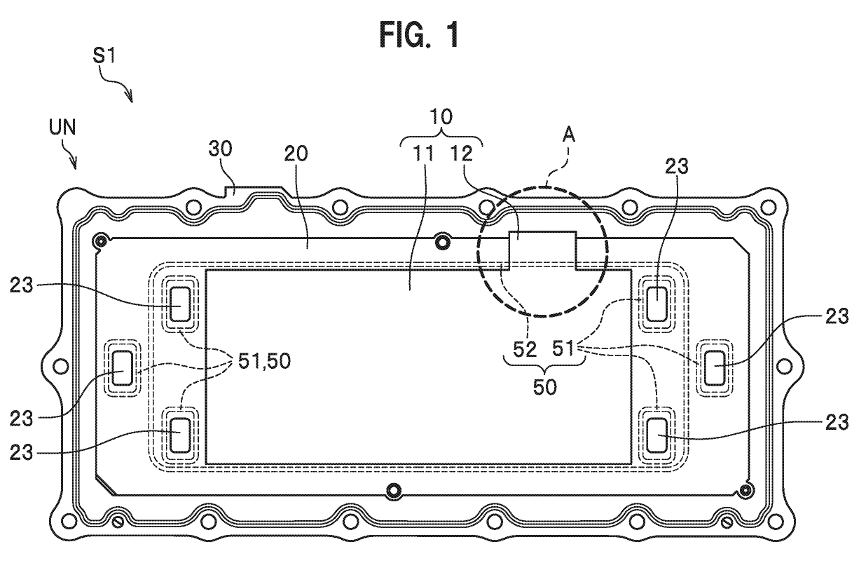

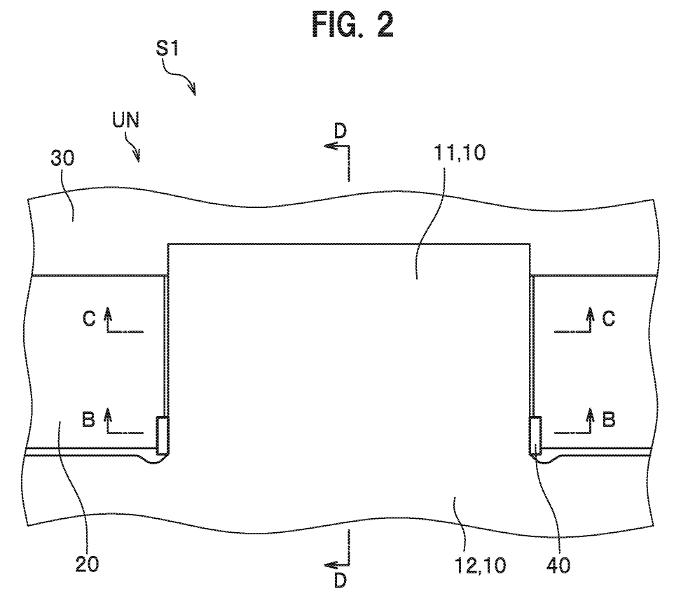

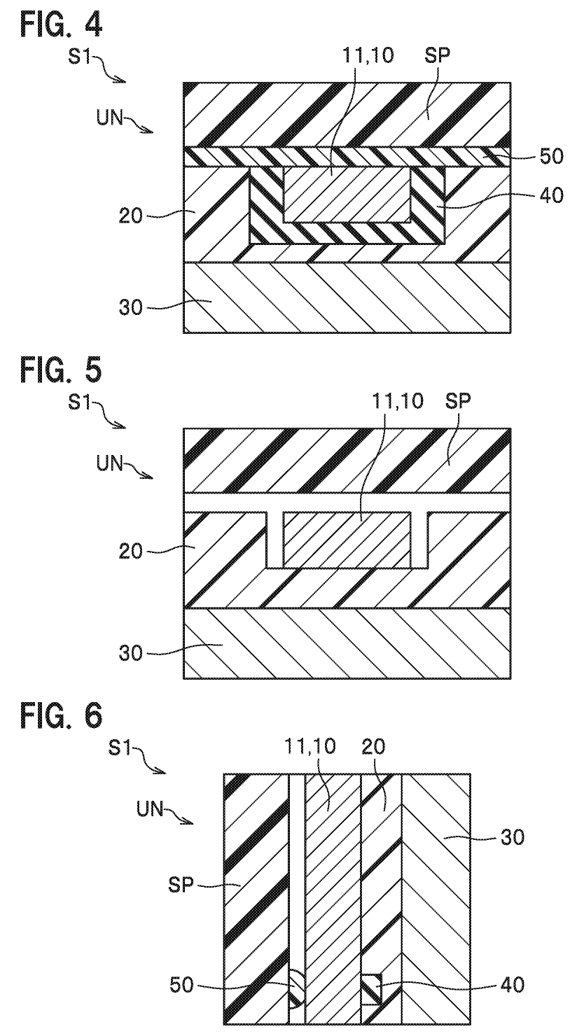

A fuel cell S1 of a first embodiment of the present disclosure will be described in detail with reference to FIGS. 1-6. In the description, the same components are given the same numerals, and duplicate descriptions are omitted.

The fuel cell S1 of the first embodiment of the present disclosure includes a stacked body (not shown) and an end unit UN. The stacked body (not shown) includes a plurality of cell stacks (not shown) stacked in a plate thickness direction. Each cell stack (not shown) mainly consists of a pair of separators and a membrane electrode assembly (not shown) interposed between the pair of separators. In other words, the separators are located at both ends of the stacked body in a stacking direction. For convenience, the separators are located at both the ends of the stacked body, and a separator, which contacts the end unit UN, is referred to as an end separator SP.

The end units UN are located at both the ends of the stacked body in the stacking direction (see FIGS. 1-3). Each end unit UN supplies power generated by the stacked body to an external device. Each end unit UN includes a current collecting plate 10, an insulating tray 20, an end plate 30, and an end-side sealing 40. The current collecting plate 10, the insulating tray 20, and the end plate 30 are stacked together in this order, starting from the cell stacks.

The current collecting plate 10 is made of a conductive metallic plate. The current collecting plate 10 includes a current collector 11 and a current extractor 12. The current collector 11 has a rectangular shape and is substantially identical in shape to the current collecting plate 10. The current extractor 12 is a rectangular tongue protruding from a peripheral edge of the current collector 11. The current extractor 12 is a terminal from which a current generated in the stacked body is supplied to an external device.

The insulating tray 20 electrically insulates the current collecting plate 10 from the end plate 30. The insulating tray 20 is a rectangular plate slightly larger than the current collecting plate 10 and made of a resin material (insulating member). The insulating tray 20 has a plate surface, which faces the cell stacks, on which a receiving recess 21, a sealing receiver 22, and channel holes 23 are provided.

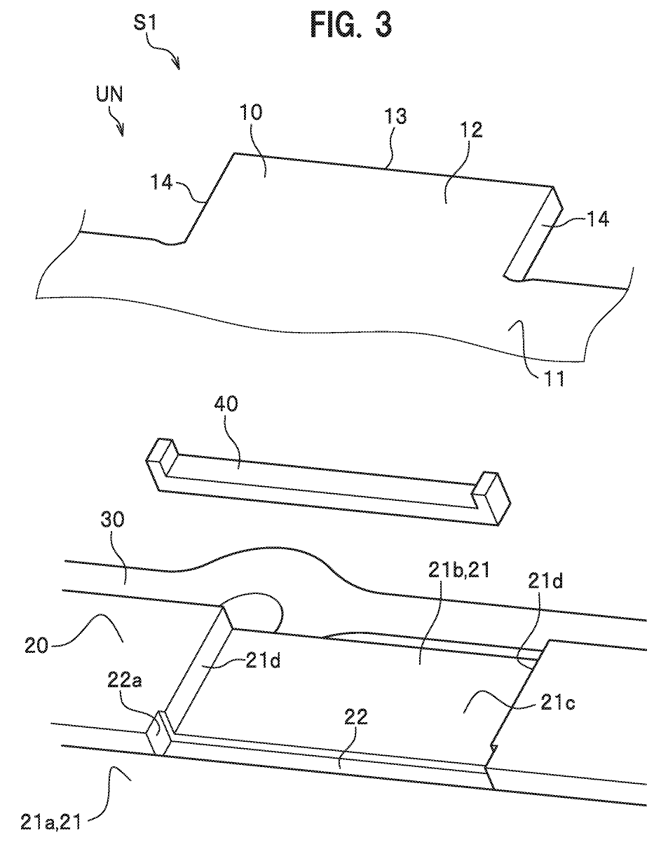

The receiving recess 21 is a groove that receives the current collecting plate 10 (see FIGS. 3-6). The receiving recess 21 includes a primary body recess 21a that receives the current collector 11 and a current extraction recess 21b that receives the current extractor 12. A depth of the body recess 21a and a depth of the current extraction recess 21b are set to be the same as a thickness of the current collecting plate 10.

The current extraction recess 21b is a groove that serves as connection of the primary body recess 21a and a periphery of the insulating tray 20. The current extractor 12 received in the current extraction recess 21b has a protrusion end 13 protruding from the insulating tray 20. This allows the current extractor 12 to be visually identified from its periphery with the end unit UN being assembled.

The sealing receiver 22 receives the end-side sealing 40 (see FIGS. 3-6). The sealing receiver 22 is formed adjacent to a bottom part 21c and a vertical wall part 21d of the current extraction recess 21b and corresponds to a base of the current extractor 12. The sealing receiver 22 is formed across the base of the current extractor 12 in a recessed and grooved manner with a substantially U-shape. The channel holes 23 are through holes that extend through the insulating tray 20 from its one surface to the other surface. The channel holes 23 are an oxidizing gas channel, a fuel gas channel, and a coolant channel. In other words, the channel holes 23 open through not only the insulating tray 20 but also the stacked body and the end plate 30 and communicate with each other.

The end-side sealing 40 is provided to enhance watertightness between the insulating tray 20 and the current collecting plate 10. The end-side sealing 40 is received in the sealing receiver 22, formed in a substantially U-shape, and held between the current extraction recess 21b of the insulating tray 20 and the current extractor 12 of the current collecting plate 10 (see FIGS. 3-6). The end-side sealing 40 uses EPT-sealer (Registered Trademark) made of a foam rubber with a primary component of Ethylene Propylene Diene Monomer (EPDM). EPT-sealer is capable of being compressed with a smaller force due to its low density, high flexibility and high compression rate. This achieves high hermeticity without deforming the current collecting plate 10 and the insulating tray 20.

A separator-side sealing 50 is held between the end separator SP and the end unit UN. The separator-side sealing 50 enhances hermeticity and watertightness between the end separator SP and the end unit UN. The separator-side sealing 50 includes channel sealings 51 and a tray sealing 52.

The channel sealings 51 are located on and adhered to the surface of the end separator SP facing the surface of the end unit UN and surround the channel holes 23 separately. The tray sealing 52 is located on and adhered to a portion that overlaps with the end-side sealing 40. The tray sealing 52 extends around the periphery of the body recess 21a at the surface of the end separator SP facing the surface of the end unit UN and extends across the base of the current extractor 12. In other words, a gap present at the periphery of the base of the current extractor 12 is sealed by the tray sealing 52 and the end-side sealing 40 (see FIGS. 1, 4, and 6).

Various sealings can be appropriately used for the separator-side sealing 50, depending on product specifications. For example, one embodiment uses a sealing method in which a gelled rubber is applied to an end separator SP, and then dried and cured, or other embodiment uses a sealing method in which O-ring and EPT-sealer are adhered to an end separator SP.

Next, advantageous functions and effects of the present embodiment will be described. The fuel cell S1 of the present embodiment includes the end-side sealing 40 that fills or seals the gap between the current collecting plate 10 and the insulating tray 20, which are included in the end unit UN. Such a configuration prevents condensed water from entering the body recess 21a from the outside through the gap between the current extractor 12 of the current collecting plate 10 and the current extraction recess 21b of the insulating tray 20, thereby reducing instability of power generation of the fuel cell S1.

The fuel cell S1 of the present embodiment further includes the tray sealing 52 that fills or seals the gap between the end separator SP and the end unit UN. Such a configuration prevents condensed water from entering the current collector 11 from the outside through the gap between the current extractor 12 of the current collecting plate 10 and the end separator SP, thereby reducing instability of power generation of the fuel cell S1.

Furthermore, in the present embodiment, the sealing receiver 22 is located at a portion that overlaps with the tray sealing 52 in the stacking direction of the end unit UN, and the end-side sealing 40 is located in the sealing receiver 22. In other words, the tray sealing 52 and the end-side sealing 40 together surround and seal the base of the current extractor 12. Such a configuration, in which the sealing members surround the base of the current extractor 12, cancels a compression reaction force on the current extractor 12. This prevents an unwanted stress from being applied to the current extractor 12, thereby achieving a stable watertightness.

### Second Embodiment

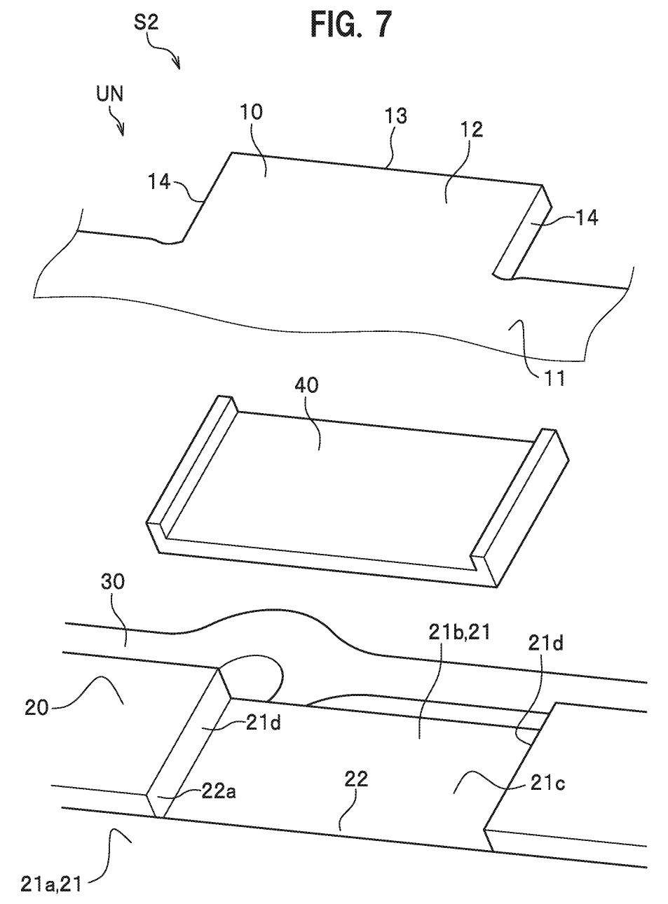

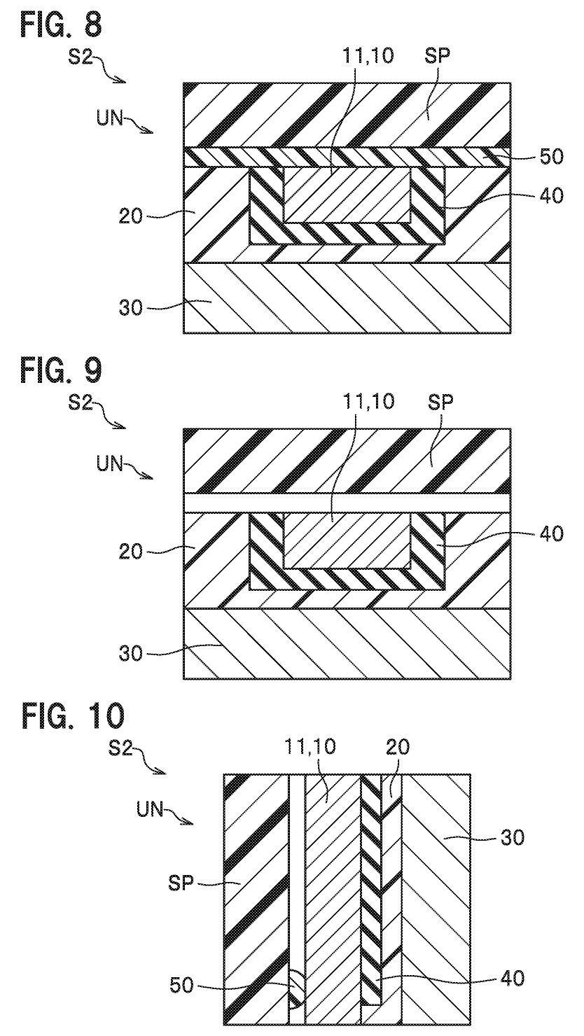

Next, a second embodiment of a fuel cell S2 will be described in detail with reference to FIGS. 7-10. In the description, the same components as the first embodiment are given the same numerals, and redundant descriptions are omitted. The fuel cell S2 of the second embodiment differs from that of the first embodiment in the configurations of the sealing receiver 22 and the end-side sealing 40 but other configurations remain the same as those in the first embodiment.

The sealing receiver 22 is recessed not only at the base of the current extractor 12 but also across the entire current extractor 12. In other words, the current extraction recess 21b is recessed slightly greater than that in the first embodiment. The end-side sealing 40 is disposed on the entire current extraction recess 21b across the base to the distal end of the current extractor 12. Such a structure visually identifies whether the end-side sealing 40 is installed with the end unit UN stacked on the stacked body. This prevents the end-side sealing 40 from being overlooked during installation, while providing the functions and effects of the first embodiment.

### Third Embodiment

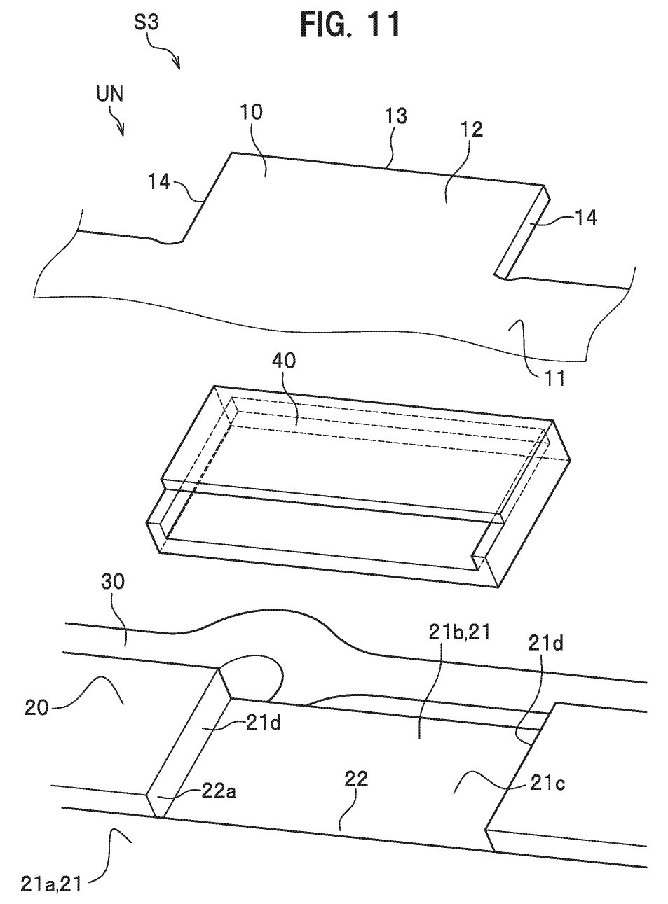

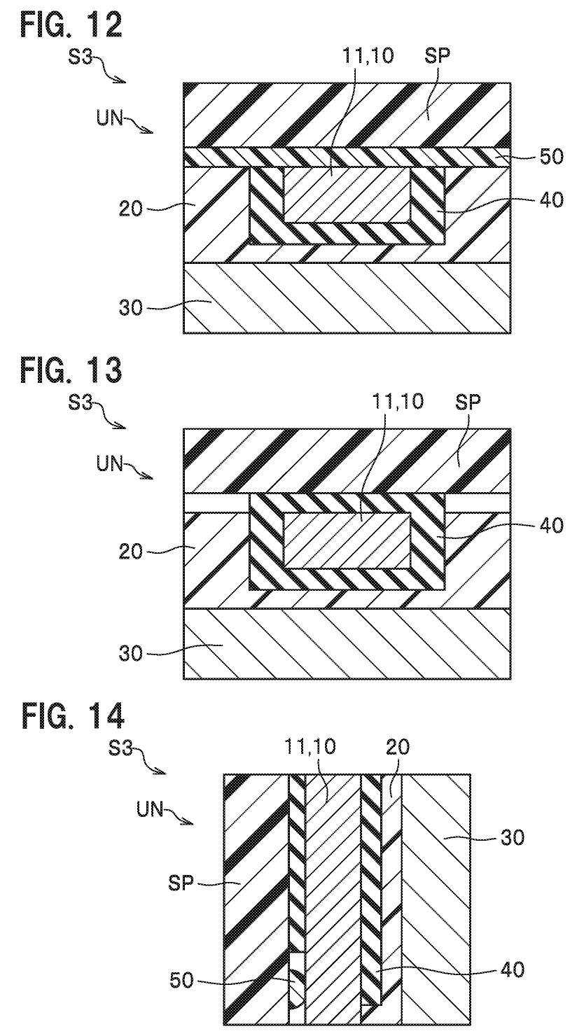

Next, a third embodiment of a fuel cell S3 will be described in detail with reference to FIGS. 11-14. In the description, the same components as the first embodiment are given the same numerals, and redundant descriptions are omitted. The fuel cell S3 of the third embodiment differs from that of the second embodiment in the configurations of the end-side sealing 40 but the configuration of the sealing receiver 22 remains the same as those in the second embodiment. The other configurations remain the same as those in the first embodiment.

A portion of the end-side sealing 40 closer to the base of the current extractor 12 has the same shape as that in the first embodiment, whereas a portion of the end-side sealing 40 closer to the distal end than the base has a closed shape. The closed-shape portion of the end-side sealing 40 is formed to allow the current extractor 12 to be inserted into the closed-shape portion. In other words, the base of the current extractor 12 is surrounded by the tray sealing 52 and the U-shape portion of the end-side sealing 40, whereas the distal end of the current extractor 12 is surrounded by the closed-shape portion of the end-side sealing 40.

Such a configuration, in which the sealing member surrounds the entire current extractor 12, cancels a compression reaction force on the current extractor 12. This prevents an unwanted stress from being applied to the current extractor 12, thereby achieving a stable watertightness. Furthermore, as in the second embodiment, the structure visually identifies whether the end-side sealing 40 is installed with the end unit UN stacked on the stacked body. This prevents the end-side sealing 40 from being overlooked during installation and achieves a stable watertightness, while providing the functions and effects of the first embodiment.

### Fourth Embodiment

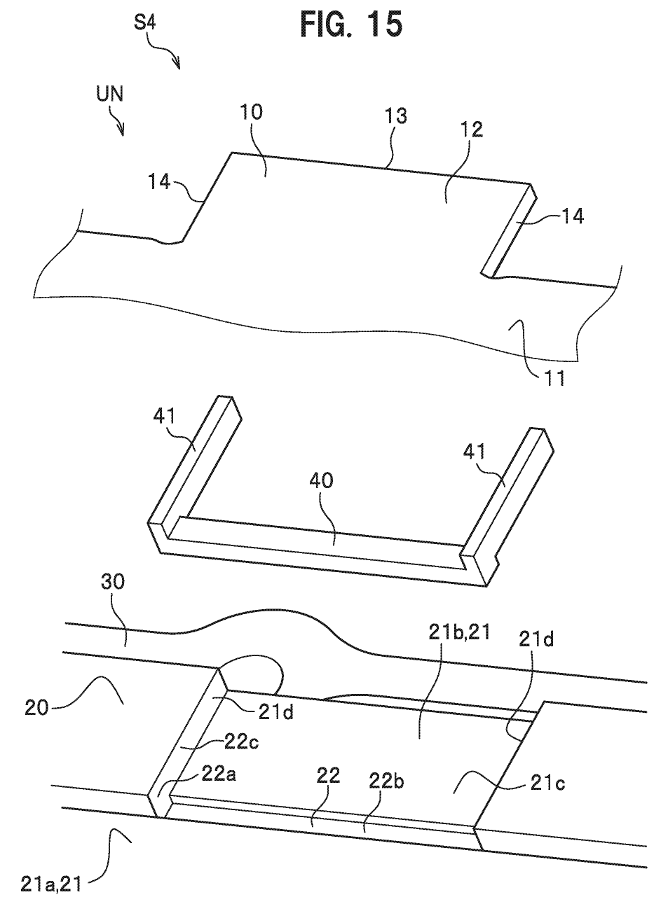

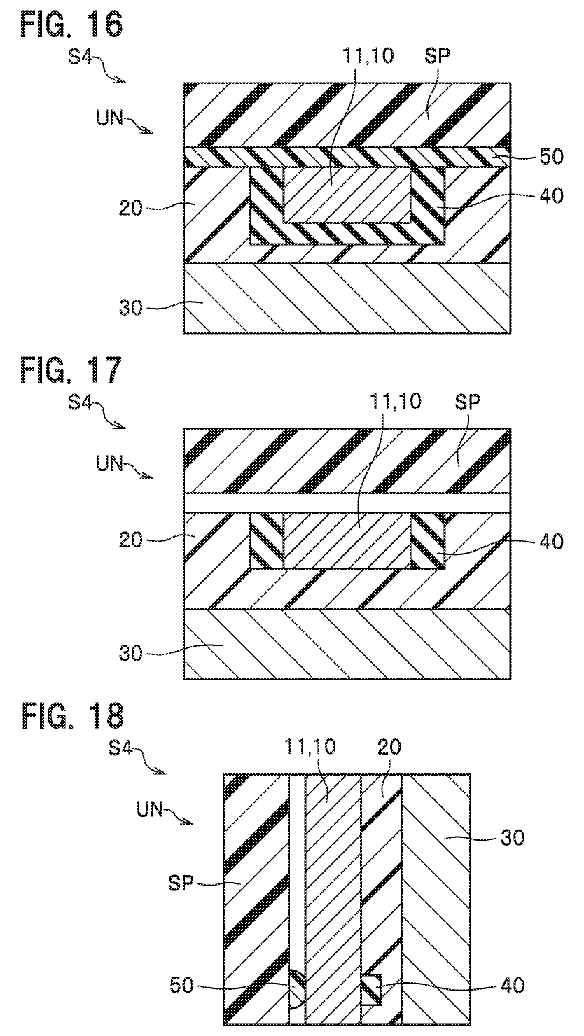

Next, a fourth embodiment of a fuel cell S4 will be described in detail with reference to FIGS. 15-18. In the description, the same components as the first embodiment are given the same numerals, and redundant descriptions are omitted. The fuel cell S4 of the fourth embodiment differs from that of the first embodiment in the configurations of the sealing receiver 22 and the end-side sealing 40 but other configurations remain the same as those in the first embodiment.

The sealing receiver 22 includes a grooved part 22b located so as to extend across the base of the current extractor 12 corresponding to the that in the first embodiment and a lateral edge part 22c recessed along a lateral edge 14 of the current extractor 12 from the base to the distal end of the current extractor 12. In other words, the sealing receiver 22 is provided such that a vertical wall 22a of the sealing receiver 22 of the first embodiment is extended to the edge of the distal end of the current extractor 12. This makes the current extraction recess 21b slightly wider than that in the first embodiment.

The end-side sealing 40 includes a lateral end sealing 41 that extends from each end of the U-shaped end-side sealing 40 of the first embodiment toward the distal end of the current extractor 12 along the lateral end 14 of the current extractor 12. Such a configuration , in which the lateral end sealing 41 is located along each lateral end 14 of the current extractor 12, cancels a compression reaction force on the current extractor 12. This prevents an unwanted stress from being applied to the current extractor 12, thereby achieving a stable watertightness. Furthermore, the structure visually identifies whether the end-side sealing 40 is installed with the end unit UN stacked on the stacked body. This prevents the end-side sealing 40 from being overlooked during installation and achieves a stable watertightness, while providing the functions and effects of the first embodiment.

What is claimed is:

1. A fuel cell comprising:
an end unit located adjacent to a cell stack, the end unit comprising;
a current collecting plate that is made of a conductive plate and has a current collector being a tongue;
an insulating tray that is made of an insulating plate and includes a receiving recess that receives the current collector;
an end plate that is made of conductive plate; and
an end-side sealing that seals a gap between the receiving recess and the current collector, wherein
the current collecting plate, the insulating tray, and the end plate are stacked together in this order, starting from the cell stack.

2. The fuel cell according to claim 1, further comprising:
a separator that is made of a plate member and located between the cell stack and the end unit; and
a tray sealing that extends across the current collector, surrounds a periphery of the receiving recess, and seals a gap between the separator and the end unit.

3. The fuel cell according to claim 2, wherein
the receiving recess includes a sealing receiver on which the end-side sealing is provided, and
the sealing receiver is located at a position that overlaps with the tray sealing in a stacking direction of the end unit.
